(19) United States
(12) Patent Application Publication
(10) Pub. No.: US 2014/0373531 A1
(43) Pub. Date: Dec. 25, 2014

(54) NATURAL GAS FUELED INTERNAL COMBUSTION ENGINE

(71) Applicant: Jim Wong, Diamond Bar, CA (US)

(72) Inventor: Jim Wong, Diamond Bar, CA (US)

(21) Appl. No.: 14/309,887

(22) Filed: Jun. 19, 2014

Related U.S. Application Data
(60) Provisional application No. 61/836,770, filed on Jun. 19, 2013.

(51) Int. Cl. F02B 37/00; F02B 43/02

(52) U.S. Cl. CPC F02B 37/00; F02B 43/02
USPC 60/605.1

(57) ABSTRACT

An internal combustion engine that can operate with 100% liquid fuel, 100% gaseous fuel and any combination in between includes a pressure expansion device used to reduce gaseous fuel pressure from the storage tank pressure to gaseous fuel injection pressure, and to extract energy from the expansion process. In one embodiment, the pressure expansion device is an air compressor that compresses intake air to an elevated pressure. In another embodiment, the pressure expansion device is a turbine, connecting to an alternator by a coupling, to generate electricity to charge the battery. The temperature of the pressure expansion device is controlled by a circuit of engine coolant or ambient air to avoid excessive deviation from room temperature. The cooled ambient air is used to cool the cabin temperature. In a further embodiment, the pressure expansion device is a turbocharger that comprises of a turbine and a compression fan.

### FIELD OF THE INVENTION

The present invention relates to an internal combustion engine that operates with a gaseous fuel and a liquid fuel, and more specifically the engine can switch between operating on 100% gaseous fuel, 100% liquid fuel, or any combination of both. The engine can also operate with only gaseous fuel system, which can be natural gas or propane. The liquid fuel can be gasoline or diesel.

### BACKGROUND OF THE INVENTION

The usage of gaseous fuel such as natural gas has significantly increased recently as an alternative fuel. Without loss of generality, the discussion of gaseous fuel focuses on natural gas, which has relatively high energy density and high octane content and consequently high anti-knocking properties. It is noted that anti-knocking is highly desirable since knocking can quickly damage many components of an internal combustion engine. A further advantage of using natural gas is low content of catalytic converter pollutants such as phosphorus and sulfur, and low proportion of carbon in comparison with liquid fuels such as gasoline or diesel. Natural gas has good combustion properties with a low degree of emissions of pollutants and lower greenhouse gas (GHG) emissions than carbon dioxide CO₂.

The gaseous fuel is often highly compressed to maximize the mass of gas stored in the tank. For natural gas, the storage pressure can be 3000 to 3600 psi, and this fuel is designated as Compressed Natural Gas (CNG). For internal combustion engines, the air fed into the cylinder is often designated as the charge air. It is noted that the charge air may contain fuel, ambient air, inert gases and engine exhaust. Currently, there are three types of natural gas fueled vehicles (NGV) offered in three different forms. The first type of NGV uses so called a “dual-fuel internal combustion engine” that can operate with any combination of gaseous fuel and liquid fuel, while the second type of NGV uses so called a “bi-fuel internal combustion engine” that has a switch to control whether the engine to operate with either gaseous fuel or liquid fuel. These two types of vehicles are more expensive because there are two complete fuelling systems. The third type is the dedicated CNG vehicles that can run with natural gas alone, and the internal combustion engine may be optimized for usage with natural gas propulsion. The dedicated CNG engines can be considered to be a subset of the bi-fuel engines that in turn is a subset of the dual-fuel engines.

The operation process of existing dual-fuel, bi-fuel and dedicated CNG vehicles is that the CNG is first compressed to 3000 to 3600 psi and enters the vehicle through the CNG fill receptacle; and the CNG is stored in one or more high-pressure storage tanks. In the dual-fuel and bi-fuel NGVs, a fuel selector permits selection of CNG or liquid fuel, while the dedicated NGV is operated solely on CNG. When needed, the CNG leaves the storage tank and passes through an electric solenoid shut-off valve that stops the flow of CNG when the engine is not running or when liquid fuel is selected.

Furthermore, the CNG travels through a high-pressure fuel line and enters a (10 micron) coalescent filter that removes aerosol compressor oil, oil droplets, and other contaminates from the CNG. The high-pressure CNG enters a pressure expansion device (PED) that is sometimes known as a pressure relief device (PRD) or pressure regulator. The PED regulates and reduces pressure from storage tank pressure to the engine injection pressure, approximately 1 to 125 psi, depending on the operation and design. The NGV may use the PED to control the outlet pressure to the engine injection pressure regardless of the storage tank pressure. More specifically, the CNG flows from the PED outlet through a low pressure fuel line to the fuel rail that distributes pressurized fuel to the CNG fuel injectors, which inject the CNG into the engine's intake valve or intake air manifold. In some designs, the CNG injectors may inject the CNG directly into the engine cylinders.

The electronic control module (ECM) controls the sequential multi-port fuel injection pulse widths or amount of CNG that the injectors inject into the engine. In some designs, the ECM can cause multiple pulses of injections in each stroke. This system allows each injector to open just before the intake valve opens. As the CNG is consumed by the engine, the storage tank pressure drops due to the depletion of the CNG.

The aforementioned approach works but has a serious deficiency. At present, none of these engine vendors attempts to increase engine efficiency by exploiting the fuel properties such as the high pressure of the natural gas. The CNG gas expands at the PED from storage tank pressure to engine injection pressure without performing work and such process is known as the free expansion. The expansion of the gaseous fuel causes the gas temperature to drop and can result in many thermal issues. Some PED designs route engine coolant to keep the gaseous injection system (in particular the PED) warm to solve the thermal issues. Therefore it is desirable to avoid or minimize the free expansion problem of the high pressure gas. Large chemical manufacture facilities use combination of expander to extract mechanical work from gas expansion from high pressure to low pressure and compressor to compress gas to higher pressure. Examples of expander/compressor include axial turbine, radial turbine, drag turbine, rotary compressor such as the Wrankel engine, rotary piston and reciprocating piston.

Turbochargers and superchargers are one group of expanders/compressors commonly used in automotives to increase the pressure of charged air entering an engine. They may include a radial-flow (centrifugal) fan/compressor or roots pump to compress the air. For the turbocharger, the compressor is driven by a turbine that extracts wasted kinetic and thermal energy from the high-temperature exhaust gas flow, at the cost of an increase in pumping losses. For the supercharger, the power to drive the compressor is driven directly by the crankshaft, and a portion of the engine output is consumed to power the supercharger.

An issue with the use of the turbocharger is “turbo lag.” Most turbocharger uses the engine exhaust to power a spinning rotor to compress ambient air and delivers a denser air-fuel mixture with higher potential energy to the cylinders. The time that the rotor needs to accelerate depends on the pressure in the exhaust manifold. An engine at low revolution per minute (rpm) generates relatively small amounts of exhaust gas, and the engine has to accelerate in order to increase the amount of exhaust gas and to increases exhaust gas pressure. The exhaust gas pressure has to increase before the exhaust gas can power the turbocharger, and the turbocharger has to rev up before it can increase the pressure in the intake system. The abovementioned process takes time and the time commonly refers to “turbo lag.” U.S. Pat. No. 6,328,024 to Kibort teaches a process to use an electric supercharger to compress the ambient air, drawing power from the stock battery. This electric supercharger comprises of an electric motor to power a fan. The deficiency of this approach is that the battery and alternator often cannot generate sufficient energy to power the supercharger for continuous usage or high frequency repeated usage. Therefore it is desirable to use an electric supercharger to compress the ambient air using energy from the battery only for a short period of time, and to obtain energy from other sources for longer duration.

Current turbochargers live in a terribly hostile environment. The turbine on the expansion side is driven by exhaust gasses that can exceed 1800° F. (1000° C.) and can be corrosive. This environment requires the use of nickel-based super-alloys and/or ceramic and/or composite for the turbine wheels. These kinds of material are expensive, heavy, and can be difficult for machining. Furthermore, the compressor wheels are often made of aluminum alloy such as 354-T61. The aluminum alloys can be lightweight, easy for machining, and thereby inexpensive. However, the current direction in compressor improvement is to operate at high boost levels and high levels of exhaust gas recirculation (EGR) to reduce emissions of nitrogen oxide (NOₓ). The increase in inlet temperature due to use of EGR, combined with the corrosive and abrasive effects of the exhaust gas, pose an increased challenge to the tensile and fatigue strength of even the best aluminum alloys. That has caused the development of titanium alloy compressor wheels made from both CNC-billet and investment-castings. Some compressor wheels are made of graphite composite materials that can be expensive. Therefore it is desirable to ease the temperature of the exhaust gas such that the compressor wheels can be constructed with lightweight low cost materials.

A crucial distinguishable characteristic difference of the gaseous fuel internal combustion engines from liquid fuel internal combustion engines is the injection of the gaseous fuel in the form of a gas. A proportion of the charge air is displaced by the gaseous fuel. As the volume of charge air reduces, the power output of the internal combustion engine reduces as well. It is well known that the power output of a reciprocating piston engine running with natural gas is approximately 15% under the same engine running with gasoline. A method to offset the diminished performance is possible through increasing the pressure of the charge air into the internal combustion engine with an air compression system comprised of a plurality of turbocharger and/or supercharger. The lowered load on engine components allows an increase in the pressure of the charge air.

U.S. Pat. No. 8,141,361 to Anderson discloses using a combination of turbocharger and supercharger to compress the charge air. The high pressure CNG is directly injected in front of the input valve of the cylinders without going through a PED. This design has all the advantages and disadvantages of turbocharger and supercharger. On the advantage side, this design compresses and increases the mass of the charge air inside the cylinders, resulting a higher power output. However, it is disadvantageous that the turbocharger may block the free passage of engine exhaust; the supercharger may demand a lot of energy from the engine when power is needed; and the gaseous fuel expands from storage tank pressure to engine injection pressure without performing work. The expansion location shifts from the PED to the gas injectors. While this may lessen the thermal issues, it is still not an efficient process.

In order to provide an optimal combustion of fuel with an acceptable levels of pollutant emissions, a precise stoichiometric combination of the air-fuel mixture ratio is often selected to provide the maximum engine power output. The gas air mixture can be achieved in certain cases of application with electronically regulated gas injection by means of an oxygen sensor and “multi-point” injection in front of the input valve of each of the cylinders of the internal combustion engine. However, the amount of emission, in particular nitrogen oxides (NOₓ), can be further reduced by increasing the volume of exhaust air recirculation (EGR). FIG. 6 illustrates the relative engine emissions vs. air-fuel ratio of one particular natural gas engine. It should be noted that these curves are engine specific as they depend on the engine designs. Also, excessively lean intake air may cause miss firing that is highly undesirable.

### SUMMARY OF THE INVENTION

The invention concerns an internal combustion engine that operates with a gaseous fuel and a liquid fuel. The engine can switch between operating on 100% gas fuel, 100% liquid fuel, or a combination of both. In particular the gaseous fuel can be natural gas or propane, and the liquid fuel can be gasoline or diesel. The gaseous fuel is stored under high pressure inside a plurality of storage tanks, and the gaseous fuel expands from the high storage tank pressure to the engine injection pressure at a pressure expansion device and is consumed by the engine.

According to one embodiment, the expansion of gaseous fuel is used to perform work at the pressure expansion device. According to another embodiment, the expansion of gaseous fuel is used to generate a pressure boost of the intake air in order to increase engine performance. According to an alternative embodiment, the expansion of gaseous fuel is used to generate electricity to charge the battery, and an electrical supercharger is used to generate a pressure boost of the intake air in order to increase engine performance.

According to a further embodiment, the electricity generated by regenerative braking system is used to cause a chemical reaction to produce gaseous fuel and/or oxidizer. The gaseous fuel and/or oxidizer are then consumed to produce power upon demand. According to another embodiment, the gaseous fuel is stored and to be consumed to produce power upon demand while the oxidizer is used to compress the gaseous fuel in the storage tank. Still according to another embodiment, the gaseous fuel is stored and is used to compress the gaseous fuel in the storage tank while the oxidizer is disposed.

Still according to a further embodiment, the engine power output is controlled by changing the volume of exhaust gas recirculation (EGR) and pressure boost of intake air (ambient air and EGR). The change of the volume of EGR and pressure boost is to follow a map of engine performance in order to minimize fuel consumption, emission for a given power output level.

### BRIEF DESCRIPTION OF THE DRAWINGS

FIG. 1 shows an embodiment of a gaseous and liquid fueled internal combustion engine used by current dual-fuel, bi-fuel and dedicated gaseous fuel vehicles.

FIG. 2 shows an embodiment of a gaseous and liquid fueled internal combustion engine that uses the expansion of gaseous fuel to power an expander/compressor.

FIG. 3 shows an embodiment of a gaseous and liquid fueled internal combustion engine that uses the expansion of gaseous fuel to power the alternator, and to use an electric supercharger to compress the ambient air.

FIG. 4 shows an embodiment of a plurality of storage tanks holding gaseous fuel.

FIG. 5 illustrates the preferred arrangement of the interior of the storage tank of the gaseous fuel.

FIG. 6 illustrates the relative engine emissions vs. air-fuel ratio of one particular natural gas engine.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

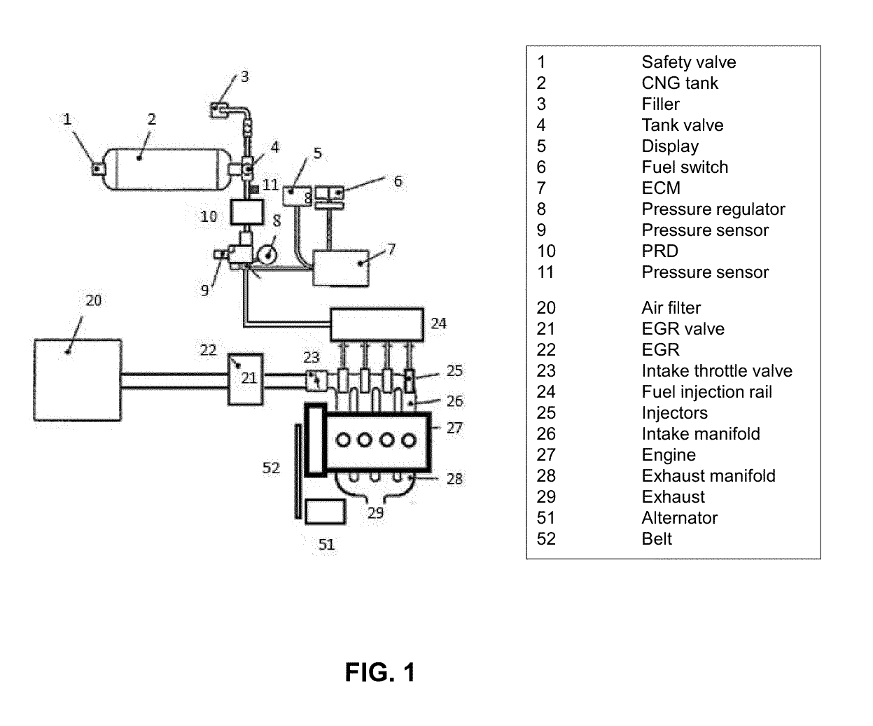

FIG. 1 illustrates a conventional gaseous and liquid fueled internal combustion engine used by current dual-fuel, bi-fuel or dedicated gaseous fuel vehicles. The liquid fuel operation is not discussed for simplicity. The engine contains a gas injection system for the purpose of the injection of the gaseous fuel into the cylinder of a conventional liquid fuel engine. The gaseous fuel is injected into the air suction route of the internal combustion engine wherein a gas-air mixture is highly compressed in the cylinders of the internal combustion engine and ignited. The ratio of gaseous fuel to air (lambda) has a range of 0.9 to 1.1 when high power is needed, and 1.4<lambda<2 during cruise and modest acceleration. For stoichiometric combination of the fuel-air-mixture, lambda=1.

The gaseous fuel is compressed to high pressure (3000 to 3600 psi for CNG) and enters the vehicle through the fuel fill receptacle (3). The gaseous fuel is stored in the one or more high-pressure storage tanks (2) and each tank may have a safety relief valve (1) to avoid over-pressure. In a dual-fuel and bi-fuel vehicle, a fuel selector (6) permits selection of gaseous or liquid fuel. A dedicated gaseous fuel vehicle operates solely on gaseous fuel.

Liquid fuel can be injected from its storage tank into the intake valve via another independent injection system as directed by the fuel selector (6) controlling the type of fuel and electronic control module (7). Switching to liquid fuel may be necessary if the display (5) shows that the tank (2) is no longer sufficiently filled.

When needed the gaseous fuel leaves the storage tank and passes through a tank valve (4) that controls flow direction of gaseous fuel from filler receptacle to storage tank or from storage tank to engine (27). The gaseous system may have an electric solenoid shut-off valve that stops the flow of gaseous fuel when the engine is not running or when liquid fuel is selected.

The CNG travels through a high-pressure fuel line that may have a coalescent filter that removes aerosol compressor oil, oil droplets and other contaminates from the gaseous fuel. The high-pressure gaseous fuel enters a pressure expansion device (PED) (10) that reduces pressure from storage tank pressure to the engine injection pressure, approximately 1 to 125 psi for CNG. The upstream and downstream pressure sensors (11 and 9) measure the local fuel pressure and report the measurements to the Electronic Control Module (ECM) (7) that may displays the results in the Display (5). A warning may also be displayed when the storage tank pressure is low. The vehicle may use the PED to control the outlet pressure to the engine injection pressure regardless of the storage tank pressure.

The gaseous fuel expands from storage tank pressure to the engine injection pressure at the PED without performing work, and the temperature may drop substantially. In some designs, coolant is used to control the temperature of the PED to avoid any thermal related issues.

The gaseous fuel flows from the PED outlet through a low pressure fuel line to a plurality of fuel rails (24) that distributes pressurized gaseous fuel to the gaseous fuel injectors (25). These injectors inject the gaseous fuel into the engine's intake valves or intake air manifold (26). (In some designs, it is one injector into the intake manifold. In other designs, it is one injector per engine cylinder.) In some designs, the gaseous fuel injectors may inject the gaseous fuel directly into the engine cylinders. The fuel-air mixture is fed into the cylinders where it is compressed. For dedicated gaseous fuel vehicles, the compression ratio depends on the type of gaseous fuel, and is preferably around 12 to 14 for CNG. For dual fuel and bi-fuel vehicles, the compression ratio is preferably unchanged from the conventional liquid fuel engine. A high compression ratio allows a late ignition point on account of the more rapid combustion. The combustion takes place preferably on the basis of an ignition map optimized for the gaseous or liquid fueling. In the combustion chamber of the cylinder the compressed mixture can be ignited preferably by means of a spark plug. The provision of the ignition energy takes place in this instance via an ignition rinse, controlled by a control unit of the internal combustion chamber.

The electronic control module (ECM) controls the sequential multi-port fuel injection pulse widths or amount of gaseous fuel the injectors inject into the engine. In some designs, the ECM also controls the number of pulses of injection per stroke. This system allows each injector to open just before the intake valve opens.

The ambient air enters the system through the air filter (20) that removes big particulates. The filtered ambient air is then mixed with a variable amount of recirculating exhaust gas at the EGR (22). The intake throttle valve (23) controls the pressure of the intake air into the intake manifold (25). The combusted products are gathered and ejected to the exhaust manifold (28) and to the engine exhaust system (29) that may contain oxygen sensor, muffler and catalytic converter. Portion of the exhaust is recirculated into the EGR (22), and the volume is controlled by an EGR valve (21). In additional to providing power to the drive shaft, the engine also provides power to accessories such as the air conditioner and also to drive a belt (52) to spin an alternator (51) that stores the electrical energy in a battery. Because the gaseous fuel partially displaces the charge air, the engine operating with gaseous fuel may produce less power than with liquid fuel in general. Another reason for the engine operating with gaseous fuel may produce less power than with liquid fuel is that the engine is optimized to operate with liquid fuel that has a different octane number. As the gaseous fuel is consumed by the engine, the storage tank pressure drops due to depletion of gas and needs to be refueled.

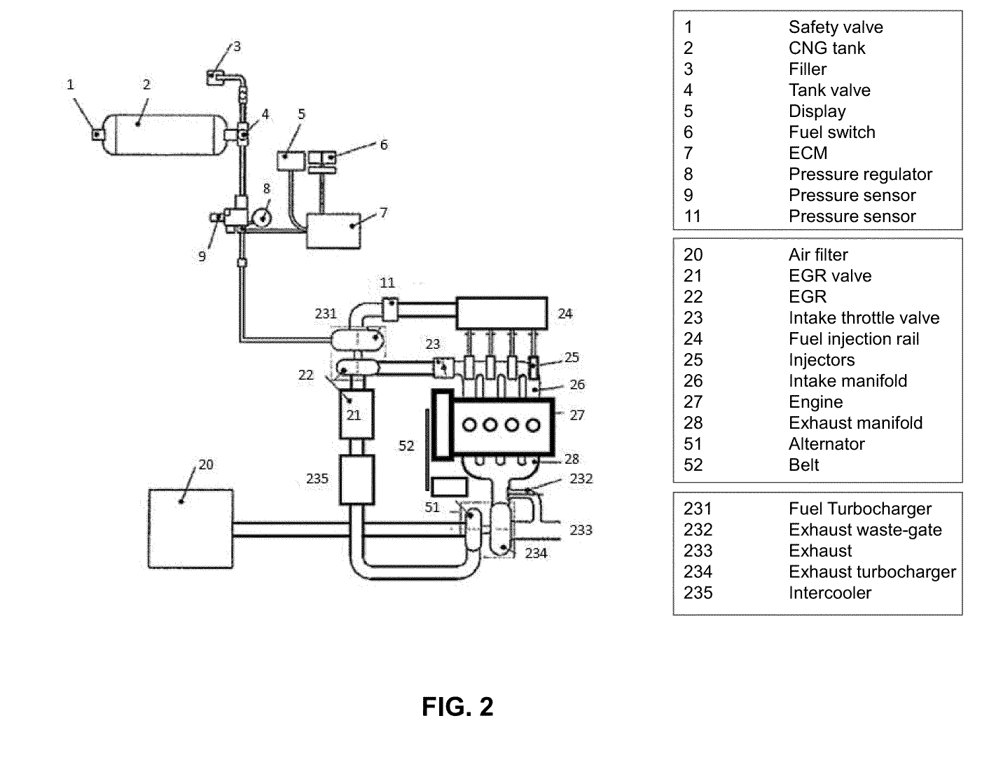

FIG. 2 shows an embodiment of a new concept of gaseous and liquid fueled internal combustion engine that uses the expansion of gaseous fuel to power an expander/compressor to compress the intake air. The gaseous fuel storage system (1-9) is similar to the existing vehicles as illustrated in FIG. 1, however, the high pressure gaseous fuel stored in tank (2) flows through the tank valve (4) and the pressure is regulated by the pressure regulator (8). The high pressure gas is used to power a turbine/piston of an expander (231) during the expansion process to the engine injection pressure. The turbine/piston of the expander is connected to a compressor used to compress the intake air to an elevated pressure. Because of the temperature drop during expansion, the gaseous fuel may absorb some heat from the ambient to raise the pressure. However, coolant may still be used to control the temperature of the expander to avoid any thermal related issues. As an alternative, the ambient air is used to control the temperature of the expander, and the cooled air is used to cool the car cabin.

The expander may have a bypass with a bypass valve. The bypass valve opens when the gaseous fuel storage tank pressure is too low so that the turbine/piston will not block the gas flow.

Similar to FIG. 1, the low pressure gaseous fuel is delivered to a plurality of fuel rail (24) that distributes pressurized fuel to the gaseous fuel injectors (25). These injectors inject the gaseous fuel into the engine's intake valves or intake air manifold (26) or directly into the engine cylinders.

The combustion products are gathered in the exhaust manifold (28) and removed from the system. For those engines that do not contain an exhaust turbocharger, the exhaust gas is passed to the exhaust system (233). For those engines that contain an exhaust turbocharger (234), the exhaust gas is used to compress intake air from the air filter (20). The performance of the exhaust turbocharger may be regulated with an exhaust waste-gate (232) that diverts the exhaust gas to the exhaust system (233).

The compressed air from the exhaust turbocharger (234) may be cooled by an intercooler (235) to lower the air temperature. The cooled compressed air is mixed with portion of the exhaust in the EGR (22), and the volume of the recirculating exhaust gas is controlled by an EGR valve (21). The cooled compressed air is mixed with the recirculating exhaust gas are then fed into the fuel expander/compressor (231) as mentioned above. Similar to FIG. 1, the engine also provides power to drive a belt (52) to spin an alternator (51) that stores the electrical energy in a battery.

It should be noted that the engine is designed to operate with 100% liquid fuel, 100% gaseous fuel, or any combination of liquid and gaseous fuel in between. When the engine operates with less than 100% gaseous fuel, the pressure boost from expansion of gaseous fuel can enhance the engine power output. Namely, for an existing car operating with gasoline, a CNG injection system can be installed therein, such that the CNG can be into the cylinder to increase the mass of ambient air.

The gaseous fuel system can be used as a light weight method to store the electric current produced by the regenerative braking system. Between the fuel turbocharger and fuel injectors (tubing, injector rails) is a container holding water and electrolyte. The generator of the regenerative braking system produces a low voltage direct current (DC) to generate hydrogen by electrolysis. The oxygen can be stored inside the fluid, disposed externally and stored in this volume. The electrolyte container may have gelling agent or baffle to keep the water from sloshing.

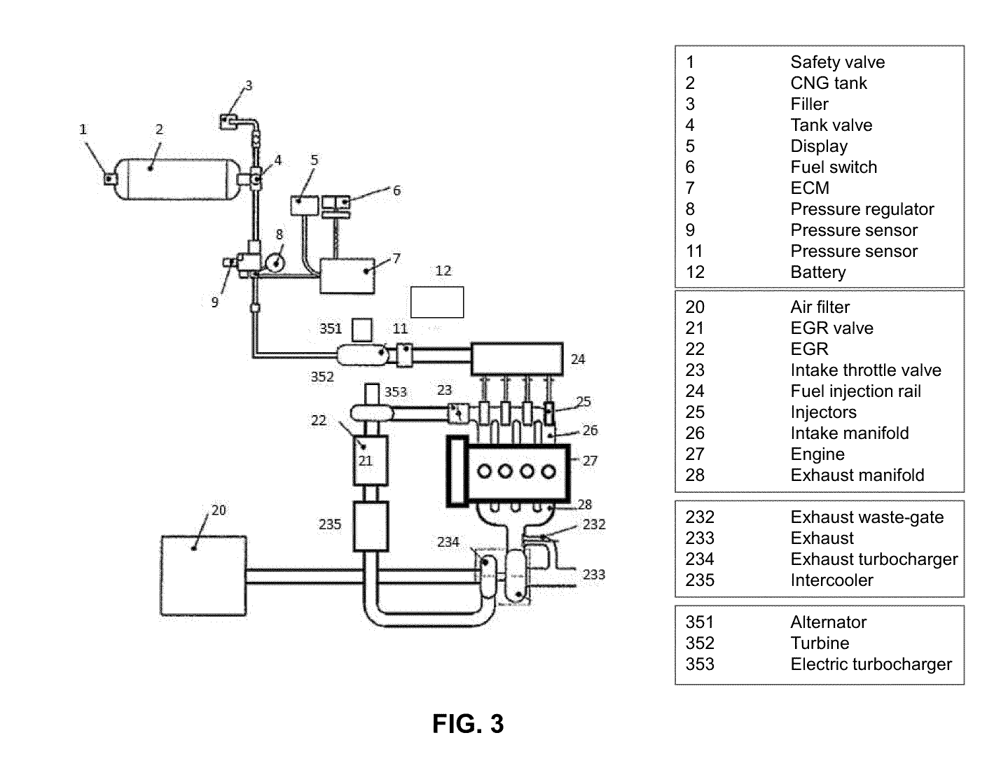

FIG. 3 shows an embodiment of a gaseous and liquid fueled internal combustion engine that uses the expansion of gaseous fuel to power the alternator, and to use an electric supercharger to compress the ambient air. The gaseous fuel storage system (1-9) is similar to the existing vehicles as illustrated in FIG. 1. Similar to FIG. 2, the high pressure gaseous fuel is used to power a turbine/piston (352) during the expansion process to the engine injection pressure, and the turbine/piston is connected to an alternator (351) with an electro-clutch or magnetic coupling. By means of the coupling, the turbine/piston is separable, if so desired, from the alternator, so that the turbine/piston will not block the gas flow when the gaseous fuel storage tank pressure is too low. The alternator can be the only system, the primary or the secondary charging system, and portion of the electrical energy is stored in the battery (12).

Similar to FIG. 2, the low pressure gaseous fuel is delivered to the fuel rail (24) and distributed to the gaseous fuel injectors (25) to be injected into the engine's intake valves or intake air manifold (26) or directly into the engine cylinders.

The combustion products are gathered in the exhaust manifold (28) and removed from the system. For those engines that do not contain an exhaust turbocharger, the exhaust gas is passed to the exhaust system (233). For those engines that contain an exhaust turbocharger (234), the exhaust gas is used to compress intake air from the air filter (20). The performance of the exhaust turbocharger may be regulated with an exhaust waste-gate (232) that diverts the exhaust gas to the exhaust system (233). The compressed air may be cooled by an intercooler (235) to lower the air temperature and mixed with portion of the exhaust in the EGR (22), and the volume of the recirculating exhaust gas is controlled by an EGR valve (21). The cooled compressed air is mixed with recirculating exhaust gas are then fed into an electric supercharger (353) connected to the battery (12). The electric supercharger is an air compressor driven by an electrical motor that can quickly reach and operate at high spin rate. For a short period of time initially, the energy needed to power the electric supercharger comes from the battery. As the flow rate of the gaseous fuel increases, the alternator spins faster and can supply electrical power to the supercharger (353). Because the battery only needs to provide energy to power the supercharger for a short period of time and the rest comes from the alternator, the electrical motor can be larger than the unit if all the energy comes from the battery.

Because of the temperature drop of the gaseous fuel during the expansion, the gaseous fuel may absorb some heat from the ambient to raise the pressure. However, coolant may still be used to control the temperature of the turbine/piston and alternator to avoid any thermal related issues.

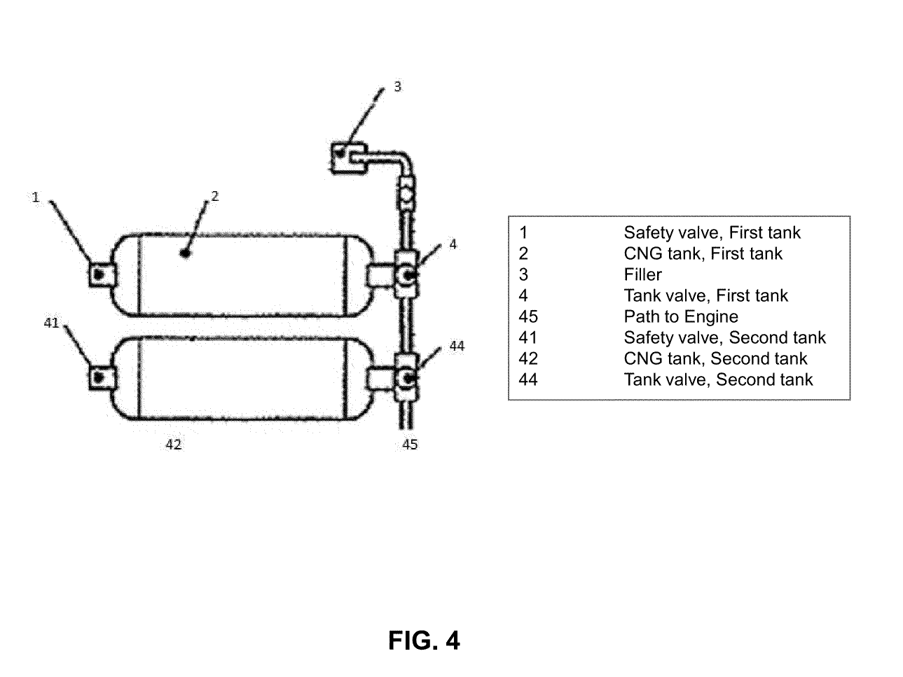

FIG. 4 illustrates a preferred arrangement of a plurality of storage tanks holding the gaseous fuel. The gaseous fuel is stored in a plurality of tank at high pressure initially. The initial storage pressure is 3000 to 3600 psi for CNG. As the gaseous fuel depletes, the pressure inside the tank decreases. Since the ambient air is compressed by the expansion of the gaseous fuel, the intake air pressure will decrease until the pressure of the gaseous fuel drops to a level that cannot spin the turbine. The preferred arrangement is to have two or more tanks (2 and 42) of gaseous fuel, each having a tank valve (4 and 44). Without loss of generality, tank (2) with tank valve (4) is the tank with lower pressure of gaseous fuel. During modest driving, tank valve 4 will open to transfer fuel from tank to engine, and tank valve (44) will close such that the gaseous fuel from tank (2) is consumed. During heavy acceleration, tank valve (44) will open and tank valve (4) will close such that the gaseous fuel from tank (42) is consumed. The opening of tank valve (44) can be manually controlled by the driver with a button on the steering wheel, a toggle switch or a paddle behind the steering wheel. The safety valves (1 and 41) are to protect the tanks from over pressure. Filler (3) is to add fuel to the tanks. During fueling, valve (4) will open to allow fueling of tank (2) and to transfer fuel to valve (4). Valve (4) will open to allow fuel to enter tank (44), but not to the engine.

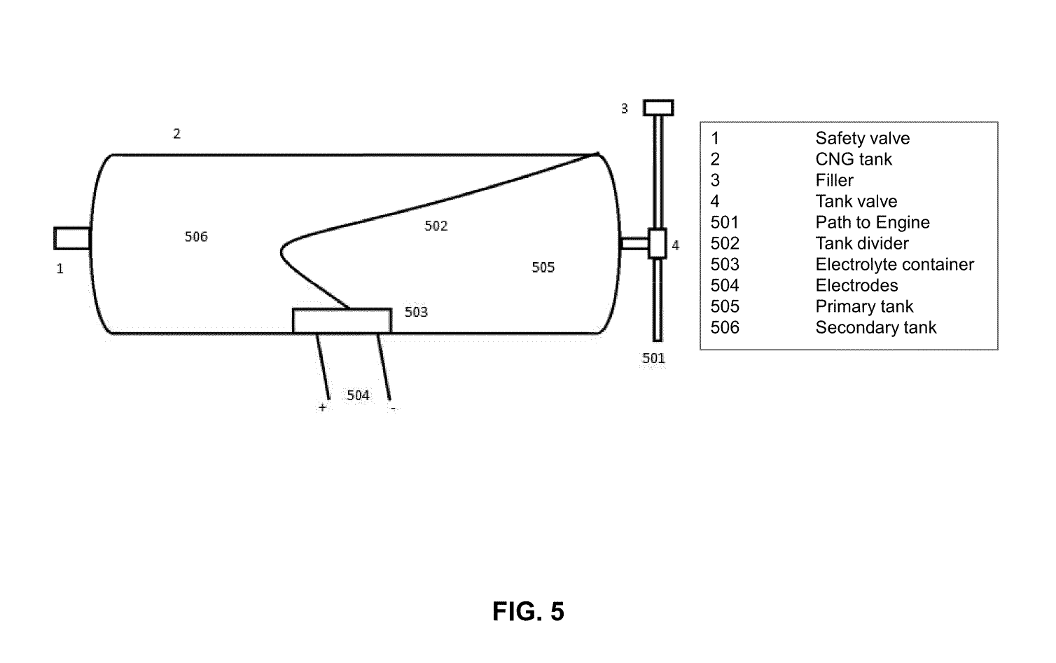

FIG. 5 illustrates the preferred arrangement of the interior of the storage tank of the gaseous fuel. The gaseous fuel is stored in a plurality of tank at high pressure initially. The initial storage pressure is 3000 to 3600 psi for CNG. As the gaseous fuel depletes, the pressure inside the storage tank (2) decreases. As the gaseous fuel pressure decreases, the pressure boost to compress the intake air (ambient air and EGR) also decreases, resulting in lower engine performance. This dependency continues until the fuel pressure can no longer spin the turbine/piston. Therefore the preferred arrangement of the gaseous fuel storage tanks is to have a device to reduce the volume of the gaseous fuel as the fuel depletes. This device can be a combination of plurality of bladders, membranes or sliding pistons. The force needed to reduce the volume of gaseous fuel can be mechanical devices such as spring; electrical motors, actuator; chemical devices such as gas generator; thermal devices such as using hot exhaust gas to increase the temperature of the gaseous fuel. The preferred arrangement is to have a bladder or piston (502) to divide each tank into two compartments (505 and 506). The primary compartment (505) holds the gaseous fuel. Inside the secondary compartment (506) is an electrolyte container (503) holding water and electrolyte. The generator of the regenerative braking system produces a low voltage direct current (DC) that is conducted to electrodes (504) and is used to generate hydrogen by electrolysis. The hydrogen produced in the electrolysis is stored in the second compartment, and is used to compress the gaseous fuel. The oxygen can be stored inside the fluid or disposed externally. The container may have gelling agent or baffle to keep the water from sloshing. Another arrangement is to store the hydrogen produced in the primary compartment, to be consumed together with the gaseous fuel. The oxygen produced in the electrolysis is stored in the second compartment, and is used to compress the gaseous fuel.

If there are multiple gaseous fuel storage tanks, the preferred arrangement is to use the electrical current to produce gases to compress the tank with highest pressure. Another embodiment is to eliminate the Tank Divide (502) and to produce gaseous fuel by electrolysis. Oxygen is being dumped outside the tank.

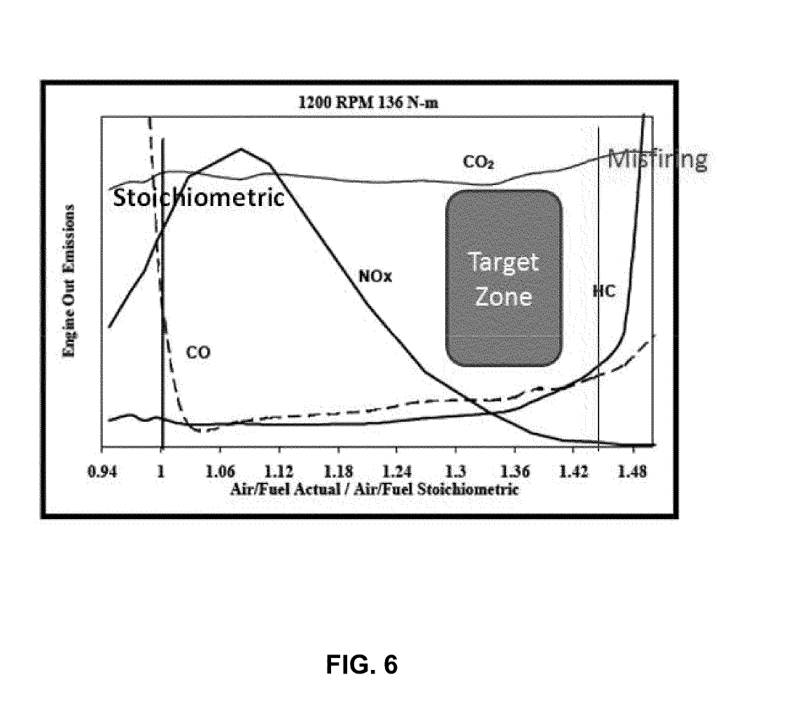

FIG. 6 illustrates the relative engine emissions vs. air-fuel ratio of one particular natural gas engine. It should be noted that these curves are engine specific as they depend on the engine designs. In order to provide an optimal combustion of fuel with an acceptable levels of pollutant emissions, a precise stoichiometric combination of the air-fuel mixture ratio (lambda=1) is often selected to provide the maximum engine power output. However, the amount of emission, in particular nitrogen oxides (NOX), can be further reduced by increasing the volume of exhaust air recirculation (EGR). It should be noted that excessively lean intake air may cause miss firing that is highly undesirable.

According to the embodiment in this patent, the engine power output can be controlled by changing the volume of exhaust gas recirculation (EGR) and pressure boost of intake air (ambient air and EGR). The change of the volume of EGR and pressure boost is to follow a map of engine performance in order to minimize fuel consumption, emission for a given power output level.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. An internal combustion engine configured to operate with 100% liquid fuel, 100% gaseous fuel or any combination thereof, comprising:
a liquid fuel internal combustion engine comprising an exhaust turbocharger system as a first stage air compressor to compress the ambient air, the exhaust turbocharger system comprising an exhaust manifold to gather combustion products, channeling them to an exhaust system; and
a gaseous fuel injection system comprising:
a plurality of storage tank of gaseous fuel;
a gaseous filler to refuel the storage tank;
a plurality of gaseous fuel injectors to inject gaseous fuel into an intake manifold, or near an intake valve, or directly into cylinders of the engine;
a tank valve on each tank to channel the gaseous fuel from the filler to fill the storage tank, to channel the gaseous fuel from the storage tank to a pressure expansion device, or to shut off gas flow when the engine is turned off; and
an Electronic Control Module (ECM) that controls the gaseous fuel injectors' pulse widths, the amount of fuel the injectors inject into the engine, and the number of pulses per stroke.

2. The internal combustion engine of claim 1, wherein the pressure expansion device is used to reduce gaseous fuel pressure from storage tank pressure to gaseous fuel injection pressure, and to extract energy from the expansion process.

3. The internal combustion engine of claim 2, wherein the pressure expansion device is used to compress intake air to an elevated pressure to increase power of the engine using extracted energy from the expansion process.

4. The internal combustion engine of claim 2, wherein the pressure expansion device is used to power accessories of a car using extracted energy from the expansion process.

5. The internal combustion engine of claim 4, wherein the pressure expansion device is used to power an alternator to produce electricity using extracted energy from the expansion process.

6. The internal combustion engine of claim 2, wherein temperature of the pressure expansion device is controlled by a circuit of engine coolant or ambient air to avoid excessive deviation from room temperature.

7. The internal combustion engine of claim 2, wherein the pressure expansion device is used to power an air conditioner compressor using extracted energy from the expansion process.

8. The internal combustion engine of claim 2, wherein the pressure expansion device is a turbocharger including a turbine and a compression fan, and the turbine and the compression fan are connected by a shaft, and the turbine extracts energy from the expansion process to power the compressor fan.

9. The internal combustion engine of claim 2, wherein the pressure expansion device is an expander and a compressor including an expander and a compression fan, and the expander and the compression fan are connected by a mechanical and/or electromechanical mean, and the expander extracts energy from the expansion process to power the compressor fan.

10. The internal combustion engine of claim 9, wherein the expander is selected from a group comprising a scroll expander, a rotary engine similar to a Wrankel engine, a rotary piston engine, a reciprocating engine, a drag turbine, an axial turbine, a radial turbine, and the compressor is selected from a group comprising a scroll compressor, a rotary engine similar to a Wrankel engine, a rotary piston engine, and a reciprocating engine.

11. The internal combustion engine of claim 9, wherein a mechanical and/or electromechanical mean is a combination of shaft, cable, electromechanical clutch and coupling.

12. The internal combustion engine of claim 1, wherein the gaseous fuel includes is 100% compressed natural gas (CNG), 100% methane, 100% ethane, 100% propane, 100% butane, 100% hydrogen, 100% carbon monoxide or any combination of these gases.

13. The internal combustion engine of claim 1, wherein the liquid fuel comprises diesel and gasoline that includes alcohol added gasoline and liquid propane.

14. The internal combustion engine of claim 6, wherein the expander and compressor is an electric turbocharger.

15. The internal combustion engine of claim 7, wherein high pressure CNG is used to increase intake air pressure to enhance gasoline engine power output.

16. The internal combustion engine of claim 1, wherein the gaseous fuel injection system is activated by pushing a button on the steering wheel; flipping a toggle switch on the dashboard; or pulling a paddle behind the steering wheel.
